(19) United States
(12) Patent Application Publication
(10) Pub. No.: US 2007/0152447 A1
(43) Pub. Date: Jul. 5, 2007

(54) Electric Energy Transducer And Method

(76) Inventor: Gerald Nicholas Pellegrini, Worcester, MA (US)

Correspondence Address: GERALD N. PELLEGRINI, 37 GRANBY RD., WORCESTER, MA, 01604, US

(21) Appl. No.: 11/306,655

(22) Filed: Jan. 5, 2006

(51) Int. Cl. H02K 7/18; F03G 7/08; F02B 63/04

(52) U.S. Cl. 290/1 R

(57) ABSTRACT

The invention utilizes the spontaneous changes in the magnetization of a material to produce electric energy in an electric circuit. These spontaneous changes occur as a result of transitions from non-equilibrium magnetic states to equilibrium magnetic states of the magnetic material.

The invention has to do with the generation of electrical energy by fluctuations in a material's magnetization. This in itself is not new. For example, electrical energy in a transformer's secondary circuit is generated by fluctuations in the magnetization of the transformer's core. The novelty associated with this invention is that the magnetization fluctuations used to generate electric power, as apposed to the transformer example, are due to spontaneous influences in the magnetic material (magnet) itself. These influences are due to the natural tendency of the magnet to reach a magnetization equilibrium state. When a magnet system is in a non-equilibrium magnetic state it will naturally and spontaneously tend to reach its equilibrium magnetic state. In so doing there will be generated electro-motive forces EMFs due to the associated changing magnetic fields, as is well known in the art. The invention takes advantage of these EMFs by generating electric power in a circuit that is electromagnetically coupled to the magnet.

Non-equilibrium magnetic states are known to exist in magnetic materials. For example, during the magnetization process the magnetization in ferromagnetic materials occurs in jumps known as Backhausen jumps. For each jump the magnetization cascades or avalanches spontaneously, indicating that the magnet is in a non-equilibrium magnetic configuration just prior to, and during, the avalanche occurrence. By proper preparation, having to do with impurities in the materials, the volume extent of these avalanches can theoretically be the entire magnet.

The invention first creates a magnetic state of the magnet system that is in non-equilibrium, such as the magnetic state just prior to, or just after the initial beginning of, a magnetization cascade or avalanche. Subjecting the magnet system to a magnetic field whose time variations are shorter than the time required for the system to reach an equilibrium state is an example of creating this non-equilibrium state of the magnet system. A coil energized by short duration current pulse circuitry provides for this non-equilibrium creating field in this example. It is to be recognized that these processes are macroscopic. After this non-equilibrium magnetic state is created the system spontaneously tends to reach an equilibrium magnetic state through changes, or avalanches, in the system's magnetization. Associated with these changes or avalanches in the magnetization, EMFs are generated.

The invention also incorporates an electrical circuit containing a coil, which may be the same coil as mentioned above or an auxiliary coil, electromagnetically coupled to the magnetic field associated with the magnet's magnetization. This electrical circuit controls the current in this coil, through current control circuitry well known in the art in the circuit, such that the current is in phase with the EMFs generated by the spontaneous changes in the magnetization. In so doing energy capable of doing useful work is transferred to the circuit. The energy transferred to the circuit during this process of the generated EMFs, as explained above, may come from the thermal energy in the magnet's lattice.

What is claimed is:

1. A method for generating electrical energy comprising the steps of:
initially creating a macroscopic non-equilibrium magnetic state of a system, where said state later spontaneously changes in time through a natural tendency to reach a macroscopic equilibrium magnetic state;
electromagnetically coupling said system to an electric circuit;
controlling electric current in said circuit such that electric energy to perform useful work is produced in said circuit by EMFs generated by said spontaneous changes.

2. A method as recited in claim 1, wherein said step of initially creating also comprising subjecting said system to a magnetic field whose time variations are shorter than the time required for said system to reach said macroscopic equilibrium state.

3. An electrical energy transducer comprising:
first means for creating a macroscopic non-equilibrium magnetic state of a system, where said macroscopic state changes in time spontaneously through a natural tendency to reach a macroscopic equilibrium magnetic state;
second means for electromagnetically coupling said system to an electric circuit;
third means for controlling electric current in said circuit such that electric energy to perform useful work is produced in said circuit by EMFs generated by said spontaneous changes.

4. An electrical energy transducer as recited in claim 3, wherein said first means also comprising means for subjecting said system to a magnetic field whose time variations are shorter than the time required for said system to reach said macroscopic equilibrium state.
